(19) United States
(12) Patent Application Publication
(10) Pub. No.: US 2016/0357673 A1
(43) Pub. Date: Dec. 8, 2016

(54) METHOD OF MAINTAINING DATA CONSISTENCY

(71) Applicant: AGENCY FOR SCIENCE, TECHNOLOGY AND RESEARCH, Singapore (SG)

(72) Inventors: Jun YANG, Singapore (SG); Qingsong WEI, Singapore (SG); Cheng CHEN, Singapore (SG)

(21) Appl. No.: 15/117,772

(22) PCT Filed: Mar. 31, 2015
(86) PCT No.: PCT/SG2015/050056

§ 371 Date: Aug. 10, 2016

(30) Foreign Application Priority Data
Apr. 3, 2014 (SG) 10201401241U

(51) Int. Cl. G06F 12/0815; G06F 12/0891; G06F 12/0875

(52) U.S. Cl. CPC G06F 12/0815; G06F 12/0875; G06F 12/0891; G06F 2212/452; G06F 2212/621

(57) ABSTRACT

A method of maintaining data consistency in a tree, the method including the steps of: storing leaf nodes in non-volatile memory, the leaf nodes comprising actual data; storing internal nodes in a memory space where data consistency is not required; and miming a CPU instruction to maintain data consistency only during modification of the leaf nodes.

### TECHNICAL FIELD

The present invention relates to a method of maintaining data consistency in a tree.

### BACKGROUND ART

The traditional layered computer architecture typically comprises a central processing unit (CPU), dynamic random access memory (DRAM) and a hard disk drive (HDD). Data consistency is typically only maintained on the HDD due to its persistency. However, with the advent of NVM (Non-Volatile Memory), the HDD may become optional and in-memory data consistency becomes a challenge in a NVM-based storage system. Also, without the HDD, the system bottleneck moves from disk I/O to memory I/O, making CPU cache efficiency more important.

Data consistency is crucial in data management systems as data has to survive any system and/or power failure. Tree data structures are widely used in many storage systems as an indexing scheme for fast data access. However, traditional approaches (such as logging and having multiple versions) to implement a consistent tree structure on disk are usually very inefficient for in-memory tree structures. During logging, before new data is written, changes (old data and new data) are written on a log. If multiple versions are kept, a first approach is to “copy-on-write” such that before new data is written, old data is copied to another place. A second approach is “versioning” where old data is not over-written and garbage collection is relied upon to delete old versions.

Write order is important for data consistency for tree structures. For example, the pointer of a new node must be updated after the node content is successfully written. For an on-disk approach, the node is synced first, and then the pointer is updated. Memory writes order is not considered. However, NVM-based in-memory tree structures must consider memory writes order.

Memory writes are controlled by the CPU. Special instructions of the CPU, such as memory fence (MFENCE), CPU cacheline flush (CLFLUSH) and CAS (“Compare-and-Swap”), are used to implement consistent in-memory tree structures. However, such instructions significantly degrade the performance of in-memory storage systems. CAS involves 8 bytes atomic writes and memory writes large than 8 bytes may cause data inconsistency.

Currently, CDDS-tree (“Consistent and Durable Data Structures”) addresses the in-memory data consistency problem for tree indexing by using MFENCE and CLFLUSH. However, all the data in the tree is versioned (i.e. “full versioning”), which results in low space utilization and requires additional/frequent garbage collection procedures under write-intensive workloads. Moreover, there is no optimization done to reduce the cost of MFENCE and CLFLUSH instructions, which is very expensive in in-memory data processing. Furthermore, the tree layout design does not consider any optimization for the CPU cache, i.e., it is a non-cache-conscious design, causing frequent CPU cache invalidation due to garbage collection.

### SUMMARY OF INVENTION

According to an aspect of the invention, there is provided a method of maintaining data consistency in a tree, comprising: storing leaf nodes in non-volatile memory, the leaf nodes comprising actual data; storing internal nodes in a memory space where data consistency is not required; and running a CPU instruction to maintain data consistency only during modification of the leaf nodes.

In an embodiment, the leaf nodes may further comprise keys that are arranged in an unsorted manner, and wherein all the keys in the leaf nodes are larger than or equal to those in its left sibling and smaller than or equal to those in its right sibling to minimize the frequency of running the CPU instruction.

In an embodiment, the CPU instruction comprises a memory fence (MFENCE) instruction and/or a CPU cacheline flush (CLFLUSH) instruction.

In an embodiment, the internal nodes are stored in a consecutive memory space such that the internal nodes can be located through arithmetic calculation.

In an embodiment, the internal nodes comprise parent-of-leaf-nodes (PLN) and other-internal-nodes (IN), the PLN being at a bottom level of the internal nodes.

In an embodiment, the PLN comprises pointers to leaf nodes such that non-volatile memory space used by the leaf nodes is allocated and manipulated dynamically.

In an embodiment, the method may further comprise inserting a new key or deleting an existing key. Inserting the new key may comprise the following steps in order: appending a new data structure to an existing data structure, wherein the new key is encapsulated in the new data structure; running the CPU instruction; increasing a count in each existing leaf node; and then running the CPU instruction. Deleting the existing key may comprise the following steps in order: flagging a data structure that is encapsulating the existing key for deletion; running the CPU instruction; increasing the count in each remaining leaf node; and then running the CPU instruction.

In an embodiment, the method may further comprise splitting an existing leaf node on condition that the existing leaf node is full when inserting the new key. Splitting the existing leaf node may comprise the following steps in order: providing a first and a second new leaf node; distributing the keys into the first and second new leaf nodes; linking the first and second new leaf nodes to a left and right sibling of the existing leaf node; and then inserting a separation key and pointer in the PLN of the first and second new leaf nodes.

In an embodiment, the method may further comprise rebuilding the tree on condition that the PLN is full when splitting the existing leaf node.

In an embodiment, the memory space where data consistency is not required may comprise dynamic random access memory (DRAM).

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 is a schematic showing a NVM-Tree, according to an embodiment of the invention.

FIG. 2 is a schematic showing in-memory organization and layout of internal nodes (INs and PLNs), according to an embodiment of the invention.

FIG. 3 is a schematic showing a layout of leaf nodes, according to an embodiment of the invention.

FIG. 4 is a schematic showing a key insertion/deletion routine in a NVM-Tree, according to an embodiment of the invention.

FIG. 5 is a schematic showing a Leaf node split routine in a NVM-Tree, according to an embodiment of the invention.

FIG. 6 is a flowchart illustrating a method of maintaining data consistency in a tree, according to an embodiment of the invention.

FIG. 7 shows the performance results of tree rebuilding according to an embodiment of the invention.

FIG. 8 shows the performance results between an embodiment of the invention (NVM-Tree) and the prior art (B+-Tree) for 1 million key (8 bytes)/data (8 bytes) insertion.

FIG. 9 shows the performance results between an embodiment of the invention (NVM-Tree) and the prior art (B+-Tree) for 1/10/100 million key (8 bytes)/data (8 bytes) insertion.

FIG. 10 shows the performance results (in terms of CPU cache efficiency) between an embodiment of the invention (NVM-Tree) and the prior art (B+-Tree) for 1/10 million key (8 bytes)/data (8 bytes) insertion.

FIG. 11 shows the performance results (in terms of CPU cache efficiency) between an embodiment of the invention (NVM-Tree) and the prior art (B+-Tree) for 10 million key (8 bytes)/data (8 bytes) insertion.

### DESCRIPTION OF EMBODIMENTS

Embodiments of the present invention will be described, by way of example only, with reference to the drawings. Like reference numerals and characters in the drawings refer to like elements or equivalents.

Embodiments of the invention are directed to a tree structure (hereinafter referred to as “NVM-Tree”), which seeks to minimize the cost of maintaining/keeping data consistency for tree indexing on Non-Volatile Memory (NVM) based in-memory storage systems.

In an implementation, the NVM-Tree stores only leaf nodes (which contain the actual/real data) in NVM while all the other internal nodes are stored in volatile memory (e.g. DRAM) or any memory space where data consistency is not required. In this manner, the performance penalty of CPU instructions/operations such as MFENCE and CLFLUSH may be significantly reduced because only the change/modification of leaf nodes requires these expensive operations (i.e. MFENCE and CLFLUSH) to keep data consistency.

Furthermore, the layout of leaf nodes is optimized in order to minimize the amount of data to be flushed. In contrast to the traditional tree design where keys are sorted in leaf nodes to facilitate the key search, keys are unsorted inside each leaf node of the NVM-Tree, while all the keys in one leaf node are larger than or equal to those in its left sibling and smaller than or equal to those in its right sibling.

When performing key insertion/update/deletion/retrieval, the NVM-Tree locates the target node in the same way as a normal B+-Tree but inside each leaf node, the NVM-Tree uses scan to find the target key. However, upon insertion, leaf nodes in the NVM do not need to shift existing keys to the right to make space for newly inserted key(s) which causes CLFLUSH for unnecessary data. This is also the case for the entire leaf node if the new key is inserted in the first slot. Rather, the newly inserted key(s) is appended in the tail of the leaf node so that only the new key needs to be flushed.

Since leaf nodes are stored in the NVM persistently and consistently, the NVM-Tree is always recoverable from system/power failure by rebuilding internal nodes from the leaf nodes using a simple scan. Moreover, to optimize the CPU cache efficiency, the internal nodes are stored in a cache-conscious layout. That is, all the internal nodes are consecutively stored in one chunk of memory space so that they can be located through arithmetic calculation without children pointers, just like a typical cache-conscious B+-Tree.

However, instead of removing all the children pointers in internal nodes, NVM-Tree adopts a hybrid solution such that the bottom level of internal nodes, PLNs (the parents of leaf nodes), contains pointers to leaf nodes so that NVM space used by leaf nodes can be allocated and manipulated dynamically. As a result of the cache-conscious design, the NVM-Tree is significantly more CPU-cache efficient than the traditional B+-Tree. Although internal nodes have to be rebuilt when any PLNs are full, the re-building time is acceptable.

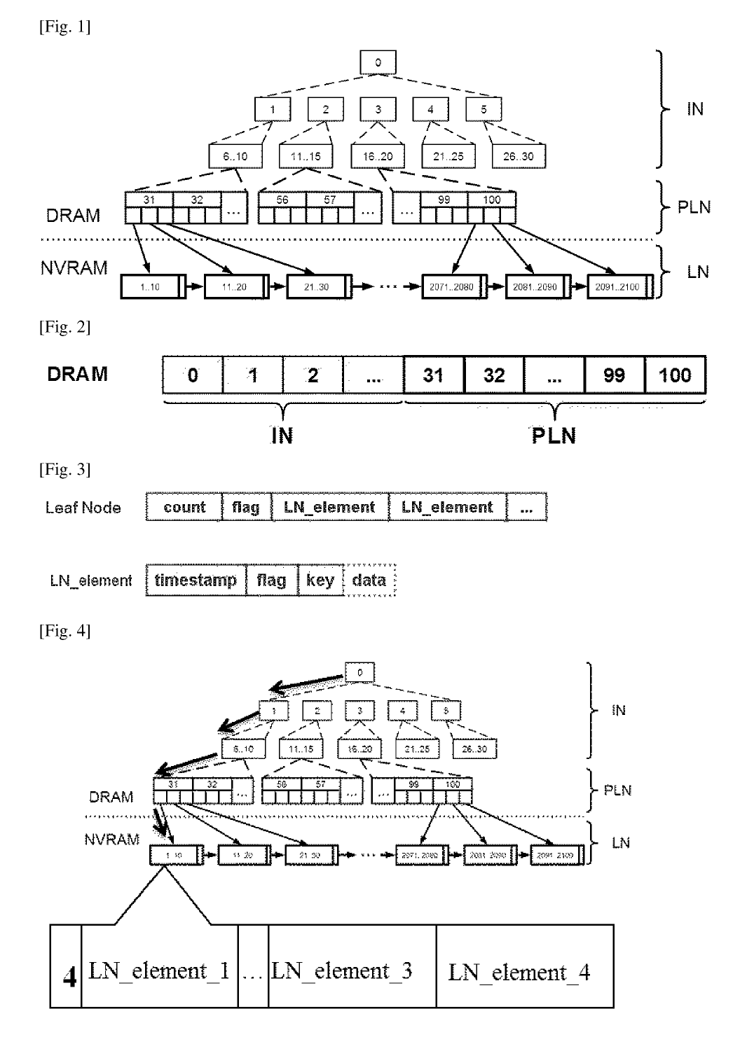

The NVM-Tree may be viewed as variant of a B+-tree. FIG. 1 is a schematic showing a NVM-Tree with m=2 and 2100 keys (i.e. nKey=2100), according to an embodiment of the invention.

The NVM-Tree comprises: (i) Leaf nodes (“LN”) (level=0), that are stored in NVRAM; and (ii) Internal nodes (level=1 . . . h−1, where h is the height of the tree), that are stored in DRAM. The internal nodes comprise: (a) Parent-of-leaf-node (“PLN”) (level=1), m keys, m+1 children and m+1 pointers; and (b) Other-internal-node (“IN”) (level=2 . . . h−1), 2m keys, 2m+1 children, no pointers.

Node size is the same as the cache line size or a multiple of it.

FIG. 2 is a schematic showing in-memory organization and layout of internal nodes (INs and PLNs), according to an embodiment of the invention. With reference to FIG. 2, internal nodes are stored in DRAM in a consecutive space and organized similar to a cache-conscious tree in which there are no pointers in INs, only pointers of leaf nodes in PLNs.

Since all internal nodes are stored sequentially, each node can be located by its node ID by arithmetic calculation. The children of a node b is from b(2m+1)+1 to b(2m+1)+(2m+1).

FIG. 3 is a schematic showing a layout of leaf nodes, according to an embodiment of the invention. Leaf nodes store all the keys and data, and are located by the children pointers in PLNs. Each leaf node is dynamically allocated when needed (e.g. upon key insertion).

With reference to FIG. 3, the keys in each leaf node are stored in an unsorted manner. They are encapsulated in a data structure called LN_element . A normal B+-tree requires the data in leaf nodes to be sorted by keys. Thus, if new data is inserted in the middle of a leaf node, the right part of data needs to be shifted to the right. All the shifted data needs CLFLUSH instruction(s) to make the changes persistent in NVM. However, in embodiments of the invention, LN_elements are preferably appended in each LN so that data shifting is totally avoided. Consequently, the amount of CLFLUSH instructions is minimized. In addition, the insertion is finished by increasing the count (8 bytes write) in each LN after appending the LN_element, so that data consistency can be kept without any logs and versioning.

FIG. 4 is a schematic showing a key insertion/deletion routine in a NVM-Tree, according to an embodiment of the invention. With reference to FIG. 4, the tree may be traversed from the root, similar to a normal B+-tree. INs and PLNs are located by arithmetic calculation. LNs are located by direct pointers. When the target LN is reached, the following steps may be taken to insert/delete the key:

1. Insert LN_element (flagged with deleted for deletion)

2. MFENCE and CLFLUSH

3. Increase the count (atomic)

4. MFENCE and CLFLUSH again

5. If LN is full, do Leaf_split

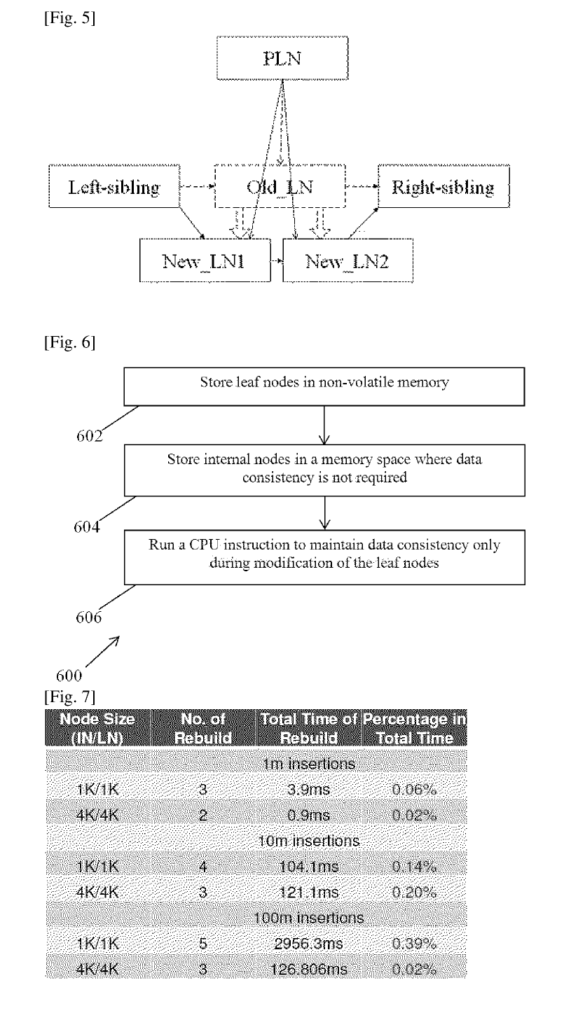

FIG. 5 is a schematic showing a Leaf node split routine in a NVM-Tree, according to an embodiment of the invention. With reference to FIG. 5, the following steps may be taken:

1. Allocate two new LNs (New_LN1 and New_LN2)

2. Distribute keys into the two new LNs:
Remove deleted keys; and
Evenly put keys to the two new LNs (Make sure keys in left LNs are smaller than that in right LNs; and keys in each node do not need to be sorted)

3. Link the new LNs in the leaf node lists Linking the new LNs to the leaf nodes lists can be done by updating three pointers: (i) New_LN1=>New_LN2, (ii) New_LN2=>right-sibling, (iii) left-sibling=>New_LN1. Updating steps (i) and (ii) are done before the (iii), and update step (iii) preferably involves atomic write so that consistency is kept. Atomic write means either the write is done successfully or nothing. For example, the pointer in the left-sibling either points to New_LN1 or the Old_LN even if a system crash happens during the write. 8-bytes atomic write means either all the 8 bytes are updated or nothing changes, i.e. it is not possible that some bytes are changed while the rest are not if the crash happens.

4. Insert the separation key and pointer of the right node in PLN. To locate New_LN1 from PLN after the split, the pointer and the separation key is to PLN; otherwise, New_LN1 is unreachable from the root. If the PLN is full, Tree rebuilding (Tree_rebuild) is performed to allocate a new set of INs to index the LNs.

The following steps may be taken to do a tree rebuild:

1. Scan all LNs and decide:
How to distribute LNs to PLNs. For example, by controlling the rebuilding frequency or adaptive to workloads. When rebuilding starts, it is possible to know the number of splits of each LN. Those LNs that are split more times than others can be considered as “hot” LNs. As few LNs as possible are distributed to the new PLN that contains “hot” LNs;
How many PLNs are needed; and
How many INs are needed.

2. Allocate a consecutive DRAM space for all INs and PLNs. This can be done in parallel without blocking read operations.

FIG. 6 is a flowchart illustrating a method of maintaining data consistency in a tree according to an embodiment of the invention. The method includes the following steps (in no particular order). At step 602, leaf nodes comprising actual data are stored in non-volatile memory. At step 604, internal nodes are stored in a memory space where data consistency is not required. At step 606, a CPU instruction is run to maintain data consistency only during modification of the leaf nodes.

FIG. 7 shows the performance results of tree rebuilding according to an embodiment of the invention. It has been found that the percentage of tree rebuilding time in the total elapsed time under various workloads with different node sizes is acceptable, which is no more than 0.4%.

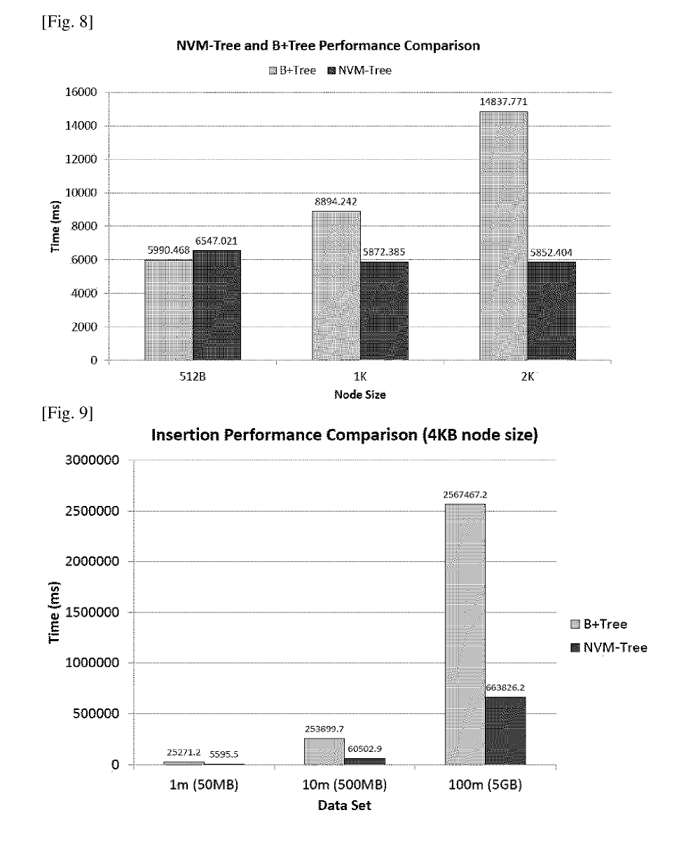

FIG. 8 shows the performance results between an embodiment of the invention (NVM-Tree) and the prior art (B+-Tree) for 1 million key (8 bytes)/data (8 bytes) insertion. It can be seen that the NVM-Tree consistently performs well with different node sizes (512B, 1K, 2K) because of the minimized cache line flush. In contrast, performance of the B+-Tree decreases when the node size increases.

FIG. 9 shows the performance results between an embodiment of the invention (NVM-Tree) and the prior art (B+-Tree) for 1/10/100 million key (8 bytes)/data (8 bytes) insertion. The node size is 4 KB. As seen from FIG. 9, the time taken by the B+-Tree is on the average about four more times than the NVM-Tree.

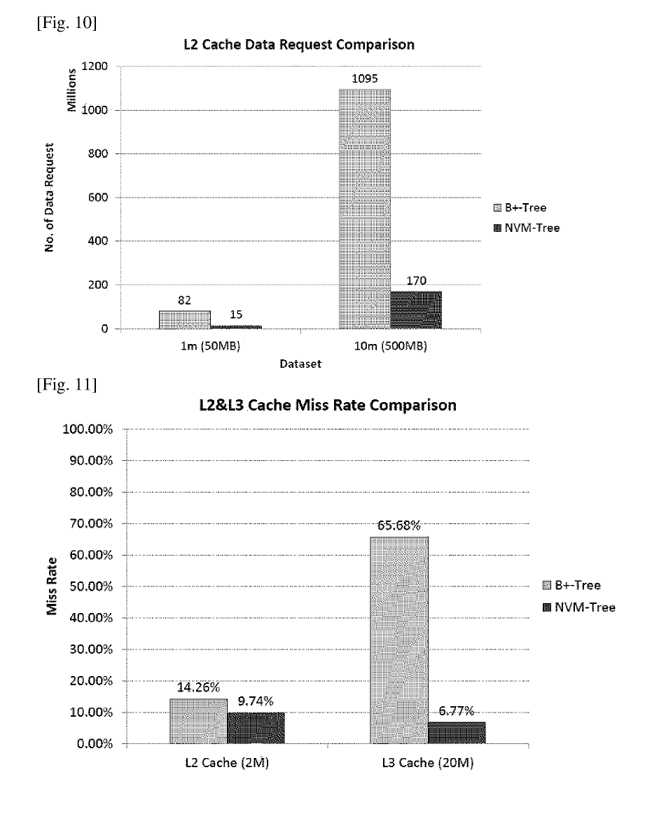

FIG. 10 shows the performance results (in terms of CPU cache efficiency) between an embodiment of the invention (NVM-Tree) and the prior art (B+-Tree) for 1/10 million key (8 bytes)/data (8 bytes) insertion. The node size is 4 KB. As seen from FIG. 10, the B+-Tree makes on the average about six times more L2 cache data requests than the NVM-Tree.

FIG. 11 shows the performance results (in terms of CPU cache efficiency) between an embodiment of the invention (NVM-Tree) and the prior art (B+-Tree) for 10 million key (8 bytes)/data (8 bytes) insertion. The node size is 4 KB. As seen from FIG. 11, the cache miss rate is better for the NVM-Tree compared to the B+-Tree.

Embodiments of the invention provide a number of advantages of the prior art. Firstly, embodiments of the invention provide high CPU cache efficiency (i.e. cache-conscious) as: (i) the Internal Node does not contain pointers resulting in more data in the same space, and (ii) there is no locking for the Internal Node as there is no CPU cache invalidation. Secondly, embodiments of the invention allow data consistency to be kept at a low cost as there is: (i) no logging or versioning, (ii) data is recoverable from a crash by rebuilding from Leaf Nodes in the NVM, and (iii) there are fewer MFENCE and CLFLUSH instructions since such operations are only in Leaf Node modifications. Thirdly, embodiments of the invention provide high concurrency as: (i) the Internal Node is latch-free, (ii) there is a light-weight latch in Parent of Leaf Node for inserting new separating key during Leaf Node split, and (iii) there is write-lock only in Leaf Node and readers are never blocked. Write-lock is implemented by CAS (“Compare-and-Swap”) and LN-element appending with timestamping.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of maintaining data consistency in a tree, comprising:
storing leaf nodes in non-volatile memory, the leaf nodes comprising actual data;
storing internal nodes in a memory space where data consistency is not required; and
running a CPU instruction to maintain data consistency only during modification of the leaf nodes.

2. The method as claimed in claim 1, wherein the leaf nodes further comprise keys that are arranged in an unsorted manner, and wherein all the keys in the leaf nodes are larger than or equal to those in its left sibling and smaller than or equal to those in its right sibling to minimize the frequency of running the CPU instruction.

3. The method as claimed in claim 1, wherein the CPU instruction comprises a memory fence (MFENCE) instruction and/or a CPU cacheline flush (CLFLUSH) instruction.

4. The method as claimed in claim 1, wherein the internal nodes are stored in a consecutive memory space such that the internal nodes can be located through arithmetic calculation.

5. The method as claimed in claim 1, wherein the internal nodes comprise parent-of-leaf-nodes (PLN) and other-internal-nodes (IN), the PLN being at a bottom level of the internal nodes.

6. The method as claimed in claim 5, wherein the PLN comprises pointers to leaf nodes such that non-volatile memory space used by the leaf nodes is allocated and manipulated dynamically.

7. The method as claimed in claim 2, further comprising inserting a new key or deleting an existing key.

8. The method as claimed in claim 7, wherein inserting the new key comprises the following steps in order:
appending a new data structure to an existing data structure to encapsulate the new key in the new data structure;
running the CPU instruction;
increasing a count in each existing leaf node; and
running the CPU instruction.

9. The method as claimed in claim 7, wherein deleting the existing key comprises the following steps in order:
flagging a data structure that is encapsulating the existing key for deletion;
running the CPU instruction;
increasing the count in each remaining leaf node; and
running the CPU instruction.

10. The method as claimed in claim 8, further comprising splitting an existing leaf node on condition that the existing leaf node is full when inserting the new key.

11. The method as claimed in claim 10, wherein splitting the existing leaf node comprises the following steps in order:
providing a first and a second new leaf node;
distributing the keys into the first and second new leaf nodes;
linking the first and second new leaf nodes to a left and right sibling of the existing leaf node; and
inserting a separation key and pointer in the PLN of the first and second new leaf nodes.

12. The method as claimed in claim 11, further comprising rebuilding the tree on condition that the PLN is full when splitting the existing leaf node.

13. The method as claimed in claim 1, wherein the memory space where data consistency is not required comprises dynamic random access memory (DRAM).
